(19) United States
(12) Patent Application Publication
(10) Pub. No.: US 2025/0097202 A1
(43) Pub. Date: Mar. 20, 2025

(54) SELECTIVE ENCRYPTION SERVICE INTERFACE FOR USE WITH THIRD-PARTY NETWORK SERVICES

(71) Applicant: StratoKey Pty Ltd., Hobart (AU)

(72) Inventor: Anthony Scotney Scotney, Hobart (AU)

(21) Appl. No.: 18/968,939

(22) Filed: Dec. 4, 2024

Related U.S. Application Data
(62) Division of application No. 17/521,534, filed on Nov. 8, 2021.
Application No. 17/521,534 is a continuation-in-part of application No. 17/039,724, filed on Sep. 30, 2020, now Pat. No. 11,838,115.
Application No. 17/039,724 is a continuation of application No. 15/853,618, filed on Dec. 22, 2017, now Pat. No. 10,798,064.
Application No. 15/853,618 is a continuation-in-part of application No. 15/808,690, filed on Nov. 9, 2017, now Pat. No. 10,594,721.
(60) Provisional application No. 62/419,960, filed on Nov. 9, 2016.

(51) Int. Cl. H04L 9/40; G06F 16/955; H04L 67/566

(52) U.S. Cl. CPC H04L 63/0281; G06F 16/955; H04L 67/566; H04L 2209/76

(57) ABSTRACT

A network computer system implements a service interface to provide encryption as a service, performs cryptographic operations on a plurality of data elements communicated between client computers of an enterprise and a third-party network service, and stores decryption logic in association with the plurality of data elements. The network computer system receives a decryption request via the service interface from a programmatic entity implemented by the third-party network service, the decryption request specifying an encrypted form of a data element. The network computer system decrypts the encrypted form of the data element to generate a decrypted form of the data element using a decryption key, of the one or more decryption keys that is associated with the data element. The network computer system provides a response to the decryption request to the programmatic entity, the response including the decrypted form of the data element.

### RELATED APPLICATIONS

This application is a divisional application of U.S. patent application Ser. No. 17/521,534, filed on Nov. 8, 2021, which is a continuation-in-part of U.S. patent application Ser. No. 17/039,724, filed on Sep. 30, 2020, which is a continuation of U.S. patent application Ser. No. 15/853,618 (now U.S. Pat. No. 10,798,064), filed on Dec. 22, 2017, which is a continuation-in-part of U.S. patent application Ser. No. 15/808,690 (now U.S. Pat. No. 10,594,721), filed Nov. 9, 2017, which claims benefit of priority to Provisional U.S. Patent Application No. 62/419,960, filed on Nov. 9, 2016; each of the aforementioned applications being incorporated by reference in their entireties for all purposes.

### BACKGROUND

Cloud, SaaS and web applications are increasingly adopted by enterprises. Using hosted services can expose security issues due to the fact that these services typically store information (often confidential) outside the corporate firewall. This shift towards cloud, SaaS and web applications has forced enterprise to search for mechanisms to independently secure these systems

### BRIEF DESCRIPTION OF THE DRAWINGS

FIG. 1 illustrates an example selective encryption computer system, according to one or more embodiments.

FIG. 2 illustrates a network computer system to selectively encrypt and/or decrypt data when one or more programmatic components or processes are triggered at a third-party network service.

FIG. 3 illustrates an example method to selectively decrypt content returned by a third-party network service.

FIG. 4 illustrates an example method for providing encryption as a service.

FIG. 5 illustrates an example method for operating a proxy service to include encryption as a service.

FIG. 6 is a block diagram that illustrates a computer system upon which embodiments described herein may be implemented.

### DETAILED DESCRIPTION

According to some examples, a computer system receives content intended for a client computer from a third-party network service, where the content includes an encrypted portion. The computer system makes a determination as to whether the encrypted portion is to be decrypted for the client computer, where the determination is made based at least in part on a historical analysis of the client computer. The computer system sends the content to the client computer in a form that is based on the determination.

Still further, in other examples, a server system implements an encryption service. In an example, a server system performs cryptographic operations on data elements communicated between client computers of an enterprise, and a network service. The server system associates cryptographic logic with the data elements that were previously subjected to the cryptographic operations. Subsequently, the server system may receive a request from a programmatic entity, where the request specifies, for example, one of the data elements that are stored in an encrypted form with the third-party network service. The server system provides a response to the request using the cryptographic logic associated with the data element of the request, where the response enables the programmatic entity to use the data element in a decrypted form.

Examples provide a network computer system that implements a service interface to provide encryption as a service. In examples, the service interface conforms to Simple Object Access Protocol (SOAP). As an alternative or addition, the service interface includes a Representation State Transfer (REST) interface.

In examples, the network computer system performs cryptographic operations on a plurality of data elements communicated between client computers of an enterprise and a third-party network service. For example, performing cryptographic operations on the plurality of data elements may include receiving an encryption request via the service interface from the programmatic entity, the decryption request including the data element in the unencrypted form, generating the encrypted from of the data element using the decryption key, and providing a response to the encryption request to the programmatic entity, the response including the encrypted form of the data element.

In examples, the network computer system stores decryption logic in association with the plurality of data elements, the decryption logic including one or more decryption keys. In examples, the decryption logic includes a set of interoperability parameters that enable the third-party network service to utilize the decrypted form of the data element.

In examples, the network computer system receives a decryption request via the service interface from a programmatic entity implemented by the third-party network service, the decryption request specifying an encrypted form of a data element stored with the third-party network service. In examples, the decryption request comprises a web service call to the service interface.

In examples, the network computer system decrypts the encrypted form of the data element to generate a decrypted form of the data element using a decryption key of the one or more decryption keys that is associated with the data element. In examples, the decryption key is associated with the data element based on data element type. As an alternative or addition, the decryption key is associated with the data element based on a client computer associated with the data element.

In examples, the network computer system provides a response to the decryption request to the programmatic entity, the response including the decrypted form of the data element.

In examples, the programmatic entity comprises a first script that executes in a backend scripting engine of the third-party network service, the first script configured to execute in response to a request, from a client computer to the third-party network service, for a web page that displays the data element. As an alternative or addition, the programmatic entity may comprise a second script that executes in a backend scripting engine of the third-party network service, the second script configured to execute in response to submission of a web form to the third-party network service by a client computer.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, servers, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

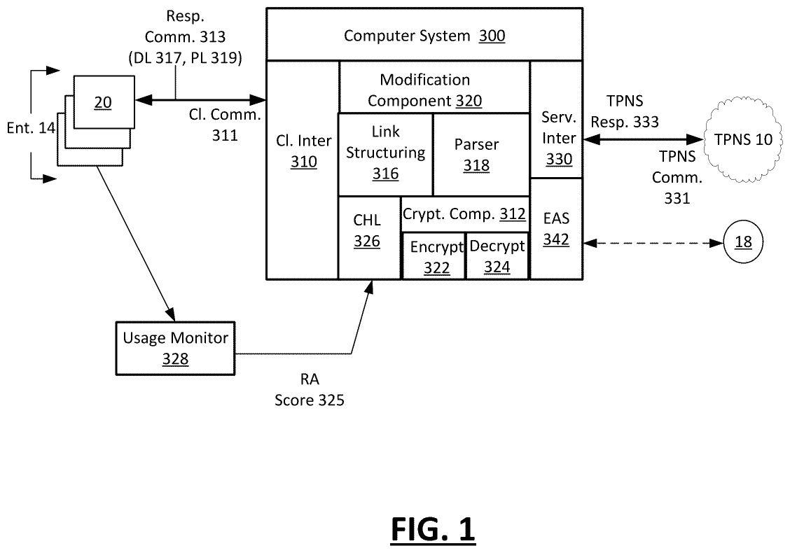

FIG. 1 illustrates an example selective encryption computer system, according to one or more embodiments. In particular, a computer system 300 may be implemented using a server, or combination of servers, to receive and forward communications between the group of client computers 20 (e.g., operating as part of the enterprise network 14) and the TPNS 10. Each of the client computers 20 may correspond to, for example, an end user terminal, work station or other computer system capable of communicating with the computer system 300 over the World Wide Web and/or other data networks.

According to some examples, the computer system 300 includes a client interface 310, a communication modification component 320 and a service interface 330. The client interface 310 can provide for the exchange of proxy communications with individual client computers 20 of the enterprise group. The modification component 320 may modify outgoing communications (e.g., client communications 311) that originate from client computers 20 and are intended for the TPNS 10, as well incoming communications (e.g., TPNS response 333) that originate from the TPNS 10 in response to the requests of the respective requesting client computers 20.

The client interface 310 may receive client communications 311 for content from individual client computers 20. In some implementations, the client communication 311 includes, for example, request links and/or session links. In some variations, the client communications 311 can include or otherwise specify data and content submissions, such as field data and/or attachments (e.g., documents or other files).

The modification component 320 includes components to modify client communications 311 that are received by the computer system 300 and are intended for the TPNS 10, as well as TPNS responses 333 that are received by the computer system 300 from the TPNS 10 and are intended for a corresponding requesting client computer 20. In an example, the modification component 320 includes one or more types of link structuring logic 316 to restructure links provided with the TPNS response 333, for the requesting client computer 20. For example, the link structuring logic 316 may be implemented to unpack request links and/or session links, such that client communications 311 can be received and restructured by the system 300 for communication to the TPNS 10. Thus, the link structuring logic 316 may restructure links of client communications 311 and of TPNS responses 333, in order to reduce or otherwise mitigate a need for certificates by the respective client computers 20.

In some examples, the modification component 320 includes cryptographic component 312, including encryption logic 322 and decryption logic 324. The encryption logic 322 can layer-in encryption of data that is included or otherwise provided with client communications 311. By way of example, the client communications 311 can include field data and/or file attachments, which the encryption logic 322 may encrypt in real-time, before the service interface 330 sends corresponding TPNS communications 331 to the TPNS 10. In some examples, the computer system 300 handles all client communications 311 originating from the client computers 20 to the TPNS 10. In this way, the computer system 300 can provide an enterprise 14 of clients 20 with an additional enhancement of encrypting data fields, attachments, and other information included with the client communications 311.

Still further, in some examples, the computer system 300 selectively encrypts data of client communications 311 before sending modified communications 331 to the TPNS 10. For example, the modification component 320 may be preconfigured to recognize certain data fields and types or classifications of data items as being sensitive. Based on such determinations, the encryption logic 322 can selectively encrypt such data fields, types or classifications, such that the TPNS 10 receives TPNS communications 331 that include encrypted data originating from the client computers 20.

When the cryptographic component 312 uses encryption logic 322 to encrypt data elements for transmission to TPNS 10, the cryptographic component 312 can store data to implement the decryption logic 324 on the encrypted data element at a later time. The data stored by the cryptographic component 312 can include, for example, a decryption key or set of keys, which the cryptographic component 312 associates with the respective data elements. By way of example, the decryption key can be specific to the data element by type (e.g., data type), client computer or use, or context (e.g., content which includes data element).

In variations, the decryption logic may include a set of interoperability parameters, which enable an entity that decrypts the data element to utilize the data element in the decrypted form. The interoperability parameters may specify, for example, a workflow or sequence of operations for an entity that requests use of the one or more data elements that the cryptographic component 312 previously operated on. For example, different interoperability parameters (e.g., formats, workflow) may be specified for different services, with the cryptographic component 312 implementing workflow variations such as retrieving data elements in encrypted form from the third-party service, and then returning/sending data elements in decrypted form once decryption is performed on the retrieved data.

In some examples, the computer system 300 further provides an encryption as a service tier for other computing nodes. The encryption service can be provided along with a proxy service, such as described with various examples. The computer system 300 may include a program entity interface 342, which can be implemented as a SOAP, REST or other interface. One or multiple third-party programmatic entities 18 can access the encryption tier of the computer system 300 via the program entity interface 342, in order to migrate, import and export data in encrypted form. By way of example, the programmatic entity 18 can correspond to a workflow, program, routine or process, implemented on either the TPNS 10 or through another service.

By way of example, the TPNS 10 may retain phone numbers and email addresses for customers of the enterprise, where the phone numbers and email addresses have been encrypted by the computer system 300. In such an example, the programmatic entity 18 can be implemented by, for example, the TPNS 10 as a workflow that requires use of the phone numbers and email addresses. During implementation of the workflow, the TPNS 10 recognizes the data in the encrypted form. The workflow may access the cryptographic component 312 via the service interface 330 (e.g., the EAS interface 342) in order to specify the phone numbers and email addresses that are in the encrypted form. In one implementation, the programmatic entity 18 provides the encrypted data to the system 300 for decryption. In another implementation, the request specifies the data elements from a storage resource or other structure of the TPNS 10 or other service. The cryptographic component 312 can identify the decryption logic 324 associated with the specified data elements, and then implement the decryption logic 324 to decrypt the specified data elements.

In other examples, the system 300 can perform cryptographic operations in order to migrate, synchronize or otherwise update data stored with TPNS 10, using encrypted data that is stored with another. In such an example, the TPNS 10 may correspond to, for example, a CRM (Customer Relationship Management) database, which holds data elements in encrypted form for use in updating an ERP (Enterprise Resource Planning) system. In such examples, interoperability parameters may specify configurations, settings, and workflow in order to enable the interoperability between distinct systems or services.

The service interface 330 can send the TPNS communication 331 to the TPNS 10, and receive corresponding TPNS responses 333 from the TPNS 10. The TPNS response 333 may also be encrypted in whole or in part. In an example, the TPNS response 333 may include content which was subject to encryption by the encryption logic 322.

As described in greater detail, the modification component 320 may alter or otherwise modify the TPNS responses 333. For example, the link structuring logic 316 may pack session links) provided with the response from the TPNS 10. By unpacking links embedded in communications 311 from individual client computers 20, and packing links provided with 333 to send to respective client computers 20 as response communications 313, the system 300 can utilize wildcard designations as between client computers 20 and the system 300 in order to reduce the number of certificates which individual client computers would otherwise need to communicate with and receive services from the TPNS 10.

In some examples, the decryption logic 324 of the modification component 320 can decrypt encrypted portions of the TPNS response 333. For example, the decryption logic 324 can process each TPNS response 333 of the TPNS 10 to decrypt content which was previously encrypted by the encryption logic 322. As an addition or variation, the decryption logic 324 may decrypt content that was encrypted by the TPNS 10 or another source.

According to some examples, the modification component 320 includes a parsing component 318 to parse the content of the TPNS response 333 to identify sensitive content elements, or portions thereof. The parser 318 may scan the content of the TPNS response 333 for one or more markers that are indicative of elements or portions of the return content being sensitive. In an example, the parser 318 can detect encrypted portions within the content of the TPNS response 333. In variations, the parser 318 may detect other markers associated with sensitive or protected content, with respect to data elements that are embedded within the content of the TPNS response 333. For example, the parser 318 may recognize certain fields of a form that is returned as part of the TPNS response 333 as inherently containing sensitive data or information, even when other fields of the form are not recognized as being sensitive. When the parser 318 identifies a portion of the content of the TPNS response 333 to include sensitive portions or elements, the modification component 320 may implement content handling logic 326 to determine how the sensitive portions or elements are to be provided to the requesting client computer 20.

In an example, the content of the TPNS response 333 includes one or more encrypted portions (e.g., data fields). The modification component 320 parses the content of the TPNS response 333 to identify encrypted data. When a portion of the TPNS response 333 is identified to be encrypted, the modification component 320 utilizes the content handling logic 326 to decrypt the selected encrypted portions of the content.

In some variations, the content handling logic 326 determines an action, or a series of actions which are to be performed with respect to content of the TPNS response 333. In some implementations, the content handling logic 326 can provide for a default set of actions (e.g., decrypt encrypted data elements), as well as one or more alternative set of actions if a predetermined condition or criterion (or set of criteria) are met.

With respect to the examples provided, the content handling logic 326 may include rules or other logic which determine the handling of the sensitive data based at least in part on (i) a type, classification, or other categorization of the data elements included with the TPNS response 333, and/or (ii) a risk assessment of the requesting client (or client that generated the client communication 311, to receive the corresponding TPNS responses 333). In examples in which the content of the TPNS response 333 includes sensitive or encrypted portions, the modification component 320 may implement the content handling logic 326 to determine whether the response communication 313 to the requesting client is to follow a default process or an alternative process. The risk assessment profile may be in the form of a score, or as one or more predefined quantifiable metrics that are deemed relevant to evaluating unwanted risks which may be associated with a requesting client, such as (i) the requesting client 20 (or its user) being unauthorized to receive the sensitive data, (ii) the requesting client 20 (or its user) being an imposter, and/or (iii) the requesting client 20 being unprotected or otherwise having poor security integrity.

According to some examples, the modification component 320 utilizes a usage monitor 328 to determine information relating to a usage profile associated with individual client computers 20. The usage monitor 328 may execute on the system 300 to aggregate and statistically analyze proxy-based data that is indicative of user behavioral traits, such as (i) access times during the course of a typical day during which the client and/or the user of the client accesses the computer system 300 and/or the TPNS 10; (ii) data usage of the client computer 20 and/or the associated user of the client, with respect to the system 300 and/or the TPNS 10; and/or (iii) network locations, devices or physical locations where the client computer 20 and/or associated user accessed the system 300 and/or the TPNS 10. In variations, the usage monitor 328 may be implemented as a separate component or service of another third-party, or of an enterprise network 14 of the client computers 20. Still further, in variations, the usage monitor 328 can be implemented at least in part by a client application, program, plug-in or process. Still further, the modification component 320 may utilize multiple usage monitors, such as a combination of a local or client base monitor that detects certain types of uses activity, and a network-based usage monitor that detects other types of activity. Additionally, the usage monitor 328 may retrieve usage information from multiple sources, such as from the browser history of individual client computers 20.

In some variations, the modification component 320 implements the usage monitor 328 to obtain a risk assessment score 325 (or other metric) that quantifies a probability of an unwanted risk with respect to the requesting client. Depending on the type of data being accessed and implementation, the usage monitor 328 may generate the risk assessment score 325 as a real-time metric, based on current or very recent usage profile information about the requesting client 20, or its associated user. The content handling logic 326 can select an action (or series of actions) that the system 300 is to perform with respect to the sensitive content element, based at least in part on the risk assessment score 325. As an addition or variation, the content handling logic 326 can select the action or series of actions based on a type, classification or other characteristic of the content portions of the TPNS response 333.

For content provided with the TPNS response 333 for a given transaction, the content handling logic 326 may implement the default process if the risk assessment score 325, which may be determined for the requesting client computer 20, indicates a risk level that is below a given threshold. Likewise, the content handling logic 326 may implement the alternative process if the risk assessment 325 score indicates the risk level for the requesting client computer 20 is above the given threshold. Under the default process, the modification component 320 may utilize the decryption logic 324 to decrypt the encrypted portions of the TPNS response 333. The client interface 310 may then send the response communication 313 to the requesting client 320, with content data that has been decrypted. Under the alternative process, the modification component 320 may send a response communication 313 to the requesting client without decrypting the encrypted data elements or portions. As an alternative or variation, the modification component 320 may remove or otherwise mask (e.g., replace the encrypted content with filler content) the sensitive or encrypted portions of the response communication, so that the requesting client 20 does not have access to even an encrypted form of the sensitive content.

In some variations, multiple threshold levels may be utilized with respect to the risk assessment score 325, and the modification component 320 may select inaction, or one or more series of actions based on the particular risk level of the client computer 20. For example, in a variation, if the risk assessment score 325 of the requesting client 20 indicates a risk level that is below a first threshold that is deemed safe, but above a second threshold that is deemed as likely to be compromised, the requesting client 20 may receive the response communication 313 with sensitive data elements being encrypted. In such an example, a user of the client computer 20 may have ability to decrypt the encrypted data elements using, for example, a previously stored key, or through an additional authentication process. If however, the risk assessment score 325 of the requesting client 20 indicates a risk level that is indicative of the client computer likely being compromised, the modification component 320 may provide the response communication 313 with the sensitive data elements being removed entirely.

Still further, in some examples, the parser 318 may parse the content of the TPNS response 333 in order to determine links to target resources which are otherwise suitable for direct access by the requesting client 20. The link structuring logic 316 may include logic to structure (or restructure) such identified links as direct links 317 that are selectable on the client computer 20 to directly access the respective target resource (e.g., page, form, etc.). By direct access, a client request from the requesting client computer 20 can select the direct link 317 to accesses the target resource through the TPNS 10 (or other network service), and without use of the system 300.

In some examples, the parser 318 of the modification component 320 parses the target resource of the TPNS response 333 to identify content elements which are of a particular type or classification. For example, the parser 318 may identify, from the content of the TPNS response 333, links which locate content elements of one or more predetermined types (e.g., Cascading Style Sheets (CSS), JavaScript or other scripts, image resources, etc.). The parser 318 may detect such content based on, for example, the extension accompanying the file name of individual links in the TPNS response 333.

Upon the parser 318 detecting such links, the link structuring logic 316 embeds a direct link 317 to the target resource within the response communication 313. Conversely, for other types of target resources (e.g., HTML/XHTML), the link structuring logic 316 may generate proxy links 319, such as packed session links.

The modification component 320 may generate the response communication 313 to include, for example, direct links 317, along with proxy links 319. If the requesting client 20 subsequently selects the direct link 317, the requesting client 20 may access the corresponding target resource on the TPNS 10 directly, without passing the request through the system 300. If, on the other hand, the requesting client 20 selects the proxy link 319 from the response communication 313, the subsequent client communication 311 is directed to the system 300.

In some examples, the modification component 320 can utilize the content handling logic 326 to determine whether a link to a target resource of a predetermined type or classification is to be structured as a direct link 317 with the response communication 313. The content handling logic 326 can implement a dynamic determination based on, for example, the load on the system 300. In such an implementation, the system 300 may increase the number of data types or classifications which can be handled through direct links, such that a greater number of direct links are used when there is more load (e.g., traffic) on the system.

As an addition or alternative, when candidate direct links 317 are found in the TPNS response 333, the content handling logic 326 may probe the target resources that are located by such direct links 317 for suitability, such as to determine whether the respective target resources are available, and not characteristic of content that is sensitive. For a given candidate direct link, if the target resource is not available, or otherwise deemed to be sensitive, the content handling logic 326 may cause the link structuring component 316 to generate a proxy link 319 for the target content. If the client 20 subsequently requests the proxy link 319, the resulting client communication 311 passes through the system 300, where, for example, the target resource can be encrypted.

By way of example, the TPNS response 333 may include:
<script type=“javascript” src=“/etc/clientlibs/granite/jquery.min.js”/>

If the content handling logic 326 implements a mode to enable direct links, then the link structuring component 316 may generate the following link for inclusion in the response communication 313:
<script type=“javascript” src=“https://salesforce.com/etc/clientlibs/granite/jquery.min.js”/>

If the content handling logic 326 implements a mode to disable the direct links 317, then the link structuring component 316 may generate the following packed link for inclusion in the response communication 313:
<script type=“javascript” src=“https://www.example.com/salesforce-com/etc/clientlibs/granite/jquery.min.js”/>

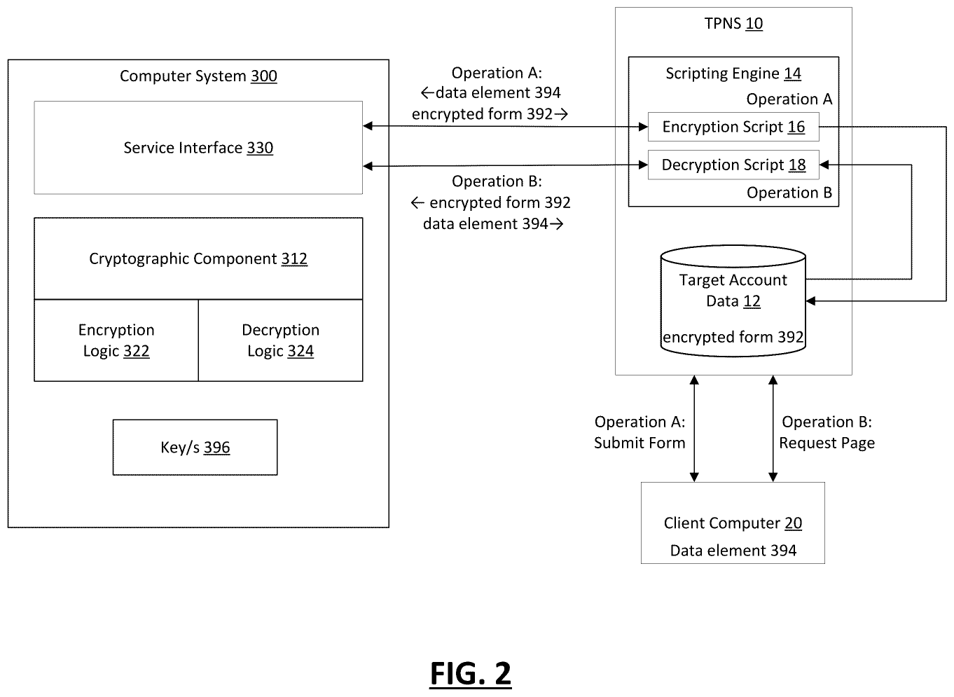

FIG. 2 illustrates a network computer system to encrypt and/or decrypt data when one or more programmatic components or processes are triggered at a third-party network service. In examples, a computer system 300 is implemented using a network computer system, such as a server or combination of servers.

The computer system 300 includes a service interface 330. In some examples, the service interface includes a web service interface, conforms to Simple Object Access Protocol (SOAP), and/or includes a Representation State Transfer (REST) interface. The service interface 330 may be called or otherwise triggered by other programmatic components or processes. For example, Operation A and Operation B each show the service interface 330 being triggered by programmatic components or processes at the TPNS 10. In examples, the TPNS 10 may implement a backend scripting engine 14 that allows an enterprise associated with a target account to provide executable code, such as but not limited to encryption script 16 and decryption script 18, to execute in response to certain actions associated with the target account.

Operation A is initiated when a web form is submitted at a client terminal 20. The web form includes a data element 394 containing sensitive information. The TPNS 10 handles the submission of the data element 394 in the web form by submitting a request to the service interface 330 of the computer system 300. In examples, the TPNS 10 automatically submits the request when a script is executed in the backend of the TPNS 10. For example, the TPNS 10 may execute an encryption script 16 automatically in response to submission of the web form by the client terminal 20. When the encryption script 16 executes, the TPNS 10 submits a request comprising the data element 394 to the service interface 330. In examples, the request may include additional data, such as additional portions of the web form data. In response to the request, the cryptographic component 312 uses the encryption logic 322 to generate the encrypted form 392 of the data element 394. The computer system 300 returns the encrypted form 392 to the TPNS 10 in response to the request. The encryption script 16 replaces the data element 394 with the encrypted form 392 so that the encrypted form 392 is stored in the target account data 12 of the TPNS 10 instead of the data element 394.

Operation B is initiated when a web page is requested by the client terminal 20. The web page is intended to include the originally submitted data element 394, which is not stored at the target account data 12 maintained by the TPNS 10. The TPNS 10 handles the web page request by submitting a request to the service interface 330 of the computer system 300. In examples, the TPNS 10 automatically submits the request when a script is executed in the backend of the TPNS 10. For example, the TPNS 10 may execute a decryption script 18 automatically in response to web page request by the client terminal 20. When the decryption script 18 executes, the TPNS 10 submits a request comprising the encrypted form 392 to the service interface 330. In examples, the request may include additional data, such as a portion of the web page requested by the client terminal 20 that includes the encrypted form 392. In response to the request, the cryptographic component 312 uses the decryption logic 324 to decrypt the encrypted form 392 and generate the data element 394. The computer system 300 returns data including the data element 394 to the TPNS 10 in response to the request. When the web page is served to the client terminal 20, the web page includes the data element 394 even though the data element 394 is not stored in the target account data 12 of the TPNS 10.

### Methodology

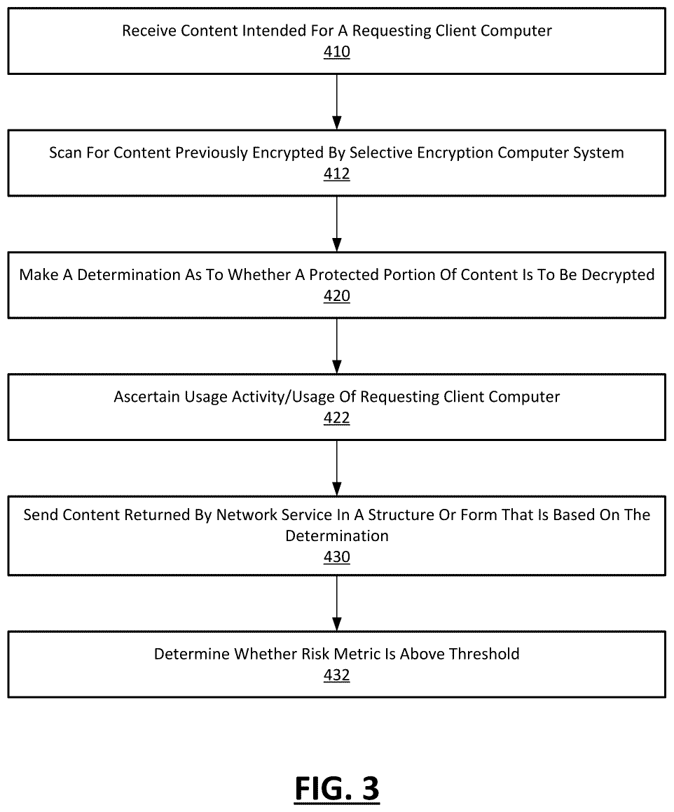

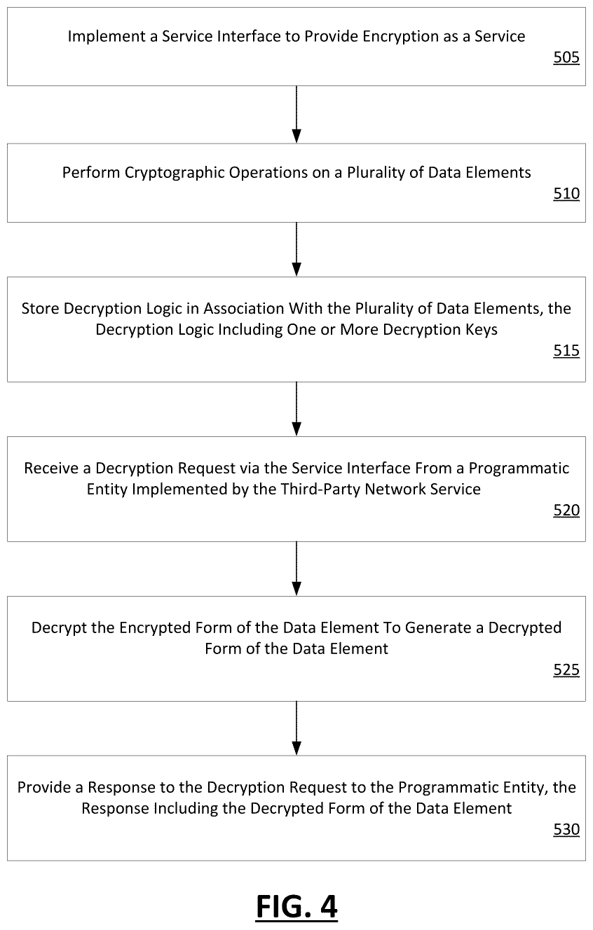

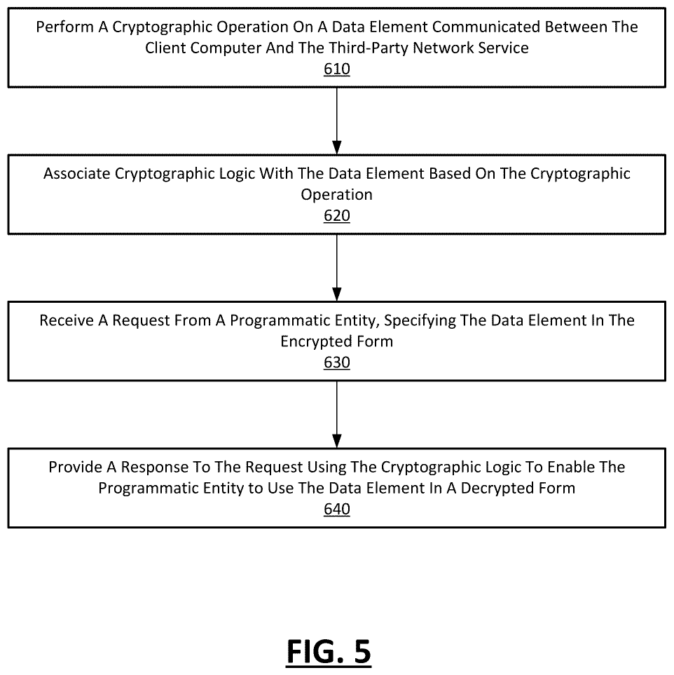

Example methods such as described with FIG. 3, FIG. 4 or FIG. 5 may be implemented using, for example, a service interface, such as the service interface 330 of the computer system 300 described with an example of FIGS. 1-2. Accordingly, reference may be made to elements of FIGS. 1-2 for purpose of illustrating suitable components for performing a step or sub-step being described.

FIG. 3 illustrates an example method to selectively decrypt content returned by a third-party network service. In the example method, the computer system 300 receives content intended for a requesting client computer from the TPNS 10 (410). The content may include a sensitive portion, such as a protected (e.g., encrypted) set of data elements. In some examples, the system 300 scans content returned by the TPNS 10 for data elements or portions which were previously encrypted by the system 300, when such content was sent by a corresponding client computer 20 to the system 300 for forwarding to the TPNS 10 (412).

The system 300 makes a determination as to whether a protected portion of content provided by the TPNS 10 is to be decrypted for a requesting client computer 20 (420). The activity or usage of the requesting client computer may be ascertained.

The system 300 may send the content returned by the TPNS 10 to the requesting computer in a structure or form that is based on the determination (430). For example, the determination may be based at least in part on determining whether a risk metric associated with the user's current or past activity exceeds a predetermined threshold (432). If the risk metric indicates a risk level that exceeds the predetermined threshold level, the system 300 may send the content returned by the TPNS 10 in encrypted form, or alternatively, in masked form (e.g., content is removed or replaced by other non-sensitive content). If, on the other hand, the risk metric indicates a risk level that is less than the predetermined threshold level, the system 300 may decrypt the content returned by the TPNS 10, and then send the decrypted content returned by the TPNS 10 to the requesting client computer 20.

FIG. 4 illustrates an example method for providing encryption as a service. In the example method, the computer system 300 implements a service interface to provide encryption as a service (505). In examples, the service interface conforms to Simple Object Access Protocol (SOAP). As an alternative or addition, the service interface includes a Representation State Transfer (REST) interface.

The computer system 300 performs cryptographic operations on a plurality of data elements communicated between client computers of an enterprise and a third-party network service (510). For example, performing cryptographic operations on the plurality of data elements may include receiving an encryption request via the service interface from the programmatic entity, the decryption request including the data element in the unencrypted form, generating the encrypted from of the data element using the decryption key, and providing a response to the encryption request to the programmatic entity, the response including the encrypted form of the data element.

The computer system 300 stores decryption logic in association with the plurality of data elements, the decryption logic including one or more decryption keys (515). In examples, the decryption logic includes a set of interoperability parameters that enable the third-party network service to utilize the decrypted form of the data element. In examples, the decryption key/s are associated with one or more data elements based on data element type. As an alternative or addition, the decryption key/s are associated with one or more data elements based on a client computer associated with the data element/s.

The computer system 300 receives a decryption request via the service interface from a programmatic entity implemented by the third-party network service (520). The decryption request specifies an encrypted form of a data element stored with the third-party network service. In examples, the programmatic entity comprises a first script that executes in a backend scripting engine of the third-party network service, the first script configured to execute in response to a request, from a client computer to the third-party network service, for a web page that displays the data element.

The computer system 300 decrypts the encrypted form of the data element to generate a decrypted form of the data element using a decryption key of the one or more decryption keys that is associated with the data element (525). The computer system 300 provides a response to the decryption request to the programmatic entity, the response including the decrypted form of the data element (530).

FIG. 5 illustrates an example method for providing encryption as a service. In the example method, the computer system 300 performs cryptographic operations on data elements communicated between client computers and one or more third-party network services (610). The cryptographic operations can include encryption and decryption operations, as well as compatibility operations.

In examples, the system 300 associates cryptographic logic with the data elements that are subject to the cryptographic operation (620). In some examples, the cryptographic component 312 implements encryption on data elements that are subsequently communicated to and stored with the TPNS 10. The cryptographic component 312 can store or otherwise maintain data to decrypt the data elements using the 324.

In providing encryption as a service, the system 300 can receive requests from a programmatic entity, where each request can specify one or more data elements which were previously encrypted by the cryptographic component 312 (630). The programmatic entity can correspond to, for example, a workflow, a program, a routine or a process implemented by the TPNS 10, or by another third-party service.

The system 300 may provide a response to the request using the cryptographic logic (640), such that the response enables the programmatic entity to use the data element in a decrypted form. In one implementation, the cryptographic component 312 decrypts data elements specified by the request, and then sends the data elements in the decrypted form to the requesting entity. In a variation, the 300 receives the request from a first entity (e.g., ERP service), and retrieves the data in encrypted form from a second entity (e.g., TPNS 10). The 312 decrypts the retrieved data and sends the data elements in decrypted form to the first entity.

In some examples, the cryptographic logic also includes interoperability parameters, including parameters that specify a format, configuration, or setting for use of the data elements in the decrypted form. In variations, the interoperability parameters can specify a workflow, or sequence of operations, for example, to ensure proper use of the data elements in the decrypted form.

### Hardware Diagrams

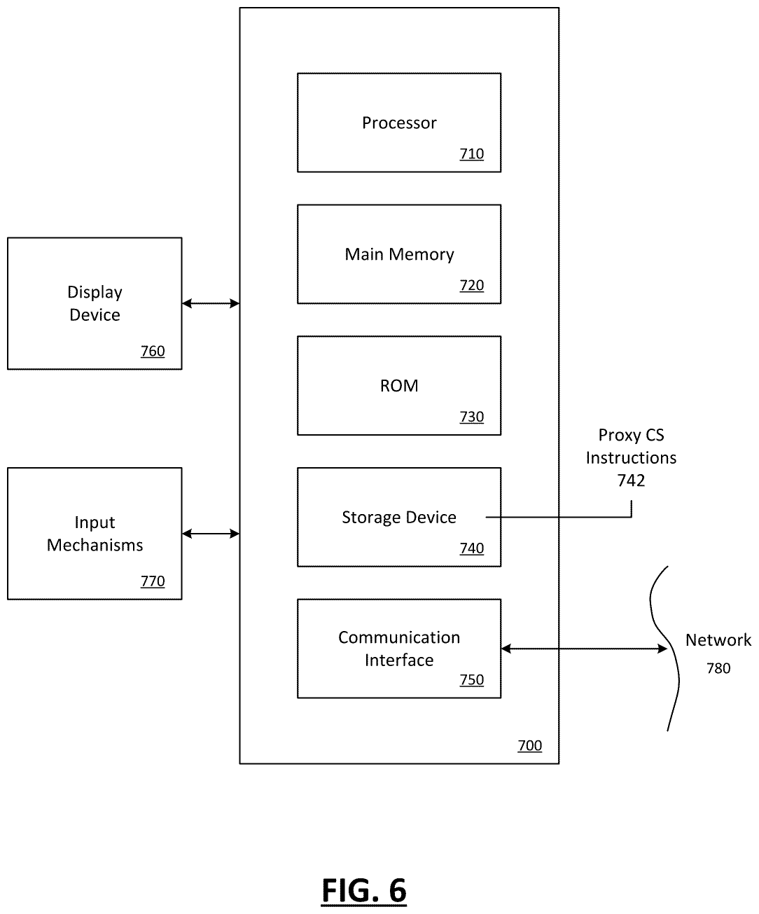

FIG. 6 is a block diagram that illustrates a computer system upon which embodiments described herein may be implemented. For example, in the context of FIG. 1 and FIG. 2, the respective computer system 300 may be implemented using a computer system such as described by FIG. 6. The computer system 300 may also be implemented using a combination of multiple computer systems as described by FIG. 6.

In one implementation, a computer system 700 includes processing resources 710, a main memory 720, a read only memory (ROM) 730, a storage device 740, and a communication interface 750. The computer system 700 includes at least one processor 710 for processing information and the main memory 720, such as a random access memory (RAM) or other dynamic storage device, for storing information and instructions to be executed by the processor 710. The main memory 720 also may be used for storing temporary variables or other intermediate information during execution of instructions to be executed by the processor 710. The computer system 700 may also include the ROM 730 or other static storage device for storing static information and instructions for the processor 710. A storage device 740, such as a magnetic disk or optical disk, is provided for storing information and instructions, including instructions 742 for implementing the example proxy computer systems 100 and 300. Additionally, the processor 710 can execute the instructions 742 to implement methods such as described with examples of FIGS. 3-5.

The communication interface 750 can enable the computer system 700 to communicate with one or more networks 780 (e.g., cellular network) through use of the network link (wireless or wireline). Using the network link, the computer system 700 can communicate with, for example, client computers 20, servers and one or more third-party network services 10.

The computer system 700 can also include a display device 760, such as an LCD monitor, or a television set, for example, for displaying graphics and information to a user, or no display device at all as with some servers. One or more input mechanisms 770, such as a keyboard that includes alphanumeric keys and other keys, can be coupled to the computer system 700 for communicating information and command selections to the processor 710. Other non-limiting, illustrative examples of input mechanisms 770 include a mouse, a trackball, touch-sensitive screen, or cursor direction keys for communicating direction information and command selections to the processor 710 and for controlling cursor movement on the display device 760.

Examples described herein are related to the use of the computer system 300 for implementing the techniques described herein. According to one embodiment, those techniques are performed by the computer system 300 in response to the processor 710 executing one or more sequences of one or more instructions contained in the main memory 720. Such instructions may be read into the main memory 720 from another machine-readable medium, such as the storage device 740. Execution of the sequences of instructions contained in the main memory 720 causes the processor 710 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following Claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors;
one or more memory resources storing a set of instructions, that, when executed by the one or more processors, cause the network computer system to provide a proxy service for a plurality of users associated with an enterprise to utilize when accessing a third-party network service, wherein in providing the proxy service, the one or more processors:
receive a content submission from the client computer intended for the third-party network service;
analyze the content submission to identify one or more sensitive data elements within the content submission, wherein a remainder of the content submission is not recognized as being sensitive;
perform an encryption operation on the one or more sensitive data elements;
store a decryption key associated with the sensitive data elements with the server system;
transmit the content submission to the third-party network service to store the content submission with the sensitive data elements in an encrypted form;
receive a request, independent of the client computer, identifying the sensitive data elements in the encrypted form;
provide a response to the request using the decryption key, the response enabling the sensitive data elements to be used in a decrypted form; and
provide a service interface comprising a program entity interface for a programmatic entity associated with the enterprise to access the sensitive data elements stored in the encrypted form with the third-party network service by the proxy service.

2. The network computer system of claim 1, wherein, in providing the service interface, the one or more processors:
receive an encryption request via the service interface from the programmatic entity, the encryption request including one or more data elements in the unencrypted form;
generate the encrypted form of the one or more data elements using one or more stored decryption keys; and
provide a response to the encryption request to the programmatic entity.

3. The network computer system of claim 1, wherein, in providing the service interface, the one or more processors:
receive a decryption request via the service interface from the programmatic entity, the decryption request specifying an encrypted form of one or more data elements stored with the third-party network service;
decrypt the encrypted form of the one or more data elements to generate a decrypted form of the one or more data elements using one or more stored decryption keys; and
provide a response to the decryption request to the programmatic entity, the response including the decrypted form of the one or more data elements.

4. The network computer system of claim 1, wherein the service interface includes a Representation State Transfer (REST) interface.

5. The network computer system of claim 1, wherein the decryption request comprises a web service call to the service interface.

6. The network computer system of claim 1, wherein the service interface conforms to Simple Object Access Protocol (SOAP).

7. The network computer system of claim 3, wherein a decryption key of the one or more stored decryption keys is associated a corresponding data element based on one or more of: a data element type of the corresponding data element, and a client computer associated with the corresponding data element.

8. The network computer system of claim 1, wherein the programmatic entity is implemented by the third-party network service as a workflow on behalf of the enterprise.

9. The network computer system of claim 1, wherein, in providing the proxy service, the one or more processors:
store decryption logic comprising a set of interoperability parameters that enable the third-party network service to utilize the decrypted form of the data element.

10. The network computer system of claim 1, wherein the programmatic entity comprises a first script that executes in a backend scripting engine of the third-party network service, the first script configured to execute in response to a request, from a client computer to the third-party network service, for a web page that displays the data element.

11. The network computer system of claim 1, wherein the programmatic entity comprises a second script that executes in a backend scripting engine of the third-party network service, the second script configured to execute in response to submission of a web form to the third-party network service by a client computer.

12. A method comprising:
providing a proxy service for a plurality of users associated with an enterprise to utilize when accessing a third-party network service, wherein in providing the proxy service comprises:
receiving a content submission from the client computer intended for the third-party network service;
analyzing the content submission to identify one or more sensitive data elements within the content submission, wherein a remainder of the content submission is not recognized as being sensitive;
performing an encryption operation on the one or more sensitive data elements;
storing a decryption key associated with the sensitive data elements with the server system;
transmitting the content submission to the third-party network service to store the content submission with the sensitive data elements in an encrypted form;
receiving a request, independent of the client computer, identifying the sensitive data elements in the encrypted form; and
providing a response to the request using the decryption key, the response enabling the sensitive data elements to be used in a decrypted form; and
providing a service interface comprising a program entity interface for a programmatic entity associated with the enterprise to access the sensitive data elements stored in the encrypted form with the third-party network service by the proxy service.

13. The method of claim 12, wherein providing the service interface comprises:
receiving an encryption request via the service interface from the programmatic entity, the encryption request including the one or more data elements in the unencrypted form;
generating the encrypted from of the one or more data elements using one or more stored decryption keys; and
providing a response to the encryption request to the programmatic entity.

14. The method of claim 12, wherein providing the service interface comprises:
receiving a decryption request via the service interface from the programmatic entity, the decryption request specifying an encrypted form of one or more data elements stored with the third-party network service;
decrypting the encrypted form of the one or more data elements to generate a decrypted form of the one or more data elements using one or more stored decryption keys; and
providing a response to the decryption request to the programmatic entity, the response including the decrypted form of the one or more data elements.

15. The method of claim 12, wherein the service interface includes a Representation State Transfer (REST) interface.

16. The method of claim 12, wherein a decryption key of the one or more stored decryption keys stored in association with the data element is associated with the data element based on the data element type.

17. The method of claim 14, wherein a decryption key of the one or more stored decryption keys is associated with a corresponding data element based on one or more of: a data element type of the corresponding data element, and a client computer associated with the corresponding data element.

18. The method of claim 12, wherein the programmatic entity comprises a first script that executes in a backend scripting engine of the third-party network service, the first script configured to execute in response to a request, from a client computer to the third-party network service, for a web page that displays the data element.

19. The method of claim 12, wherein the programmatic entity comprises a second script that executes in a backend scripting engine of the third-party network service, the second script configured to execute in response to submission of a web form to the third-party network service by a client computer.

20. A computer-readable medium storing instructions that, when executed by one or more processors, cause the one or more processors to:
provide a proxy service for a plurality of users associated with an enterprise to utilize when accessing a third-party network service, wherein in providing the proxy service, the one or more processors:
receive a content submission from the client computer intended for the third-party network service;
analyze the content submission to identify one or more sensitive data elements within the content submission, wherein a remainder of the content submission is not recognized as being sensitive;
perform an encryption operation on the one or more sensitive data elements;
store a decryption key associated with the sensitive data elements with the server system;
transmit the content submission to the third-party network service to store the content submission with the sensitive data elements in an encrypted form;
receive a request, independent of the client computer, identifying the sensitive data elements in the encrypted form;
provide a response to the request using the decryption key, the response enabling the sensitive data elements to be used in a decrypted form; and
provide a service interface comprising a program entity interface for a programmatic entity associated with the enterprise to access the sensitive data elements stored in the encrypted form with the third-party network service by the proxy service.
